(19) United States
(12) Patent Application Publication
(10) Pub. No.: US 2026/0017533 A1
(43) Pub. Date: Jan. 15, 2026

(54) ENTROPY-BASED DRIFT-AWARE FEDERATED LEARNING SOLUTION ROBUST AGAINST ENVIRONMENTS WITH HETEROGENEOUS DATA

(71) Applicant: Dell Products L.P., Round Rock, TX (US)

(72) Inventors: Jonathan Mendes De Almeida, Brasília (BR); Renam Castro da Silva, São José dos Campos (BR); Victor da Cruz Ferreira, Rio de Janeiro (BR)

(21) Appl. No.: 18/768,767

(22) Filed: Jul. 10, 2024

(51) Int. Cl. G06N 3/098; G06N 3/084

(52) U.S. Cl. CPC G06N 3/098; G06N 3/084

(57) ABSTRACT

Entropy based federated learning is disclosed. In federated learning, a model is trained at multiple clients using corresponding local data. An entropy associated with the local training is determined and provided, along with a model update, to a central server. The central server selects specific clients to participate in the current aggregation operation based on the entropy values. This minimizes the number of drifted and noisy clients that are included in the aggregation operation. The model updates of the selected clients are aggregated and a new or updated global model is generated. To aid in accounting for data heterogeneity, the clients may be grouped and a new or updated global model may be generated for each of the groups using model updates from corresponding selected clients.

### TECHNOLOGICAL FIELD OF THE DISCLOSURE

Embodiments disclosed herein generally relate to federated learning and continual learning. More particularly, at least some embodiments relate to systems, hardware, software, computer-readable media, and methods for drift-aware federated learning in the context of heterogeneous data.

### BACKGROUND

Federated learning is a distributed machine learning framework for training machine learning models. In federated learning, a global model is distributed to client nodes that locally train the global model using their own data. Updates to the model are transmitted back to a central node. The central node accumulates or combines the updates received from the client nodes and updates the global model. This process is repeated until convergence of the global model is achieved. Advantageously, federated learning also promotes data privacy and security by training on the individual client nodes.

In the classical federated learning framework, the training process occurs in a distributed manner at the edge. This framework trains a shared model by aggregating locally computed updates using, for example, the FedSGD or the FedAVG algorithms. Nonetheless, the heterogeneous and dynamic nature of this procedure due to many distributed clients in the federation makes achieving this goal challenging.

For example, federated learning may encounter problems related to data heterogeneity and drift. More specifically, data heterogeneity and drifted clients in the federation impairs the global model's convergence speed (i.e., more training rounds are required). This is a challenging and relevant problem when trying to implement effective federated learning systems. In fact, selecting the clients to participate in a training round, in light of at least these concerns, is considered to be an NP-hard problem and may impact the convergence speed. There is therefore a need to improve the convergence speed by improving the manner in which drifted clients and heterogeneous data are handled.

In classical federated learning, a subset of the clients are selected to participate in the update aggregation phase after performing local training. After selecting clients and incorporating their updates into a new or updated global model, the server pushes the new or updated global model back to the participating devices. This iterative training process continues until convergence is reached or some stopping criterion is satisfied.

Selecting the participating clients is a significant aspect of federated learning. Although a random approach can be suitable for some use cases, randomly selecting clients may negatively impact the federated learning efficiency in terms of performance/convergence time and also lead to biased testing sets. More specifically, this approach is not typically suitable for heterogeneous and dynamic environments. Stated differently, there is a need to improve the manner in which concept drift and heterogeneous data is handled in federated learning and there is a need to address the communication overhead that emerges from slow convergence.

It is understood that some clients may be more important than other clients with regard to the training or updates of a federated learning round and that the important clients may vary from one federated learning round to the next. Conventionally, a measurement for influence or importance of clients in the federation may be computed and used to select the clients that may participate in a training round.

For example, an influence-based approach may rely on a model deviation technique. The deviations of the local updates from the global updates are leveraged to identify negatively influential clients with noisy samples. However, because this approach is based on Hessian Vector Product and Randomized Kaczmarz methods, a large computation and communication overhead in incurred.

In another example, an importance-based approach orchestrates the aggregation phase based on losses of the local models. This approach uses a loss-based statistical model utility to quantify the changes in the clients' importance and select which clients should participate in the aggregation phase. The utility is based on the aggregated training loss of a client, which is dynamically calculated by summing up the losses of the data samples belonging to this client. The additional overhead is reduced in this case when compared with the influence-based approach. However, the overhead may limit its application in resource-constrained edge use cases.

### BRIEF DESCRIPTION OF THE DRAWINGS

In order to describe the manner in which at least some of the advantages and features of one or more embodiments may be obtained, a more particular description of embodiments will be rendered by reference to specific embodiments thereof which are illustrated in the appended drawings. Understanding that these drawings depict only typical embodiments and are not therefore to be considered to be limiting of the scope of this disclosure, embodiments will be described and explained with additional specificity and detail through the use of the accompanying drawings, in which:

FIG. 1 discloses aspects of federated learning that includes entropy-based client selection for update aggregation;

FIG. 2A discloses aspects of selecting clients to participate in a training round based on entropy;

FIG. 2B discloses aspects of determining entropy of a client based on prediction confidence;

FIG. 2C discloses aspects of federated learning that includes entropy-based client selection and client clustering to account for data heterogeneity; and

FIG. 3 discloses aspects of a computing device, system, or entity.

### DETAILED DESCRIPTION OF SOME EXAMPLE EMBODIMENTS

Embodiments disclosed herein generally relate to federated learning. More particularly, at least some embodiments relate to systems, hardware, software, computer-readable media, and methods for entropy-based client selection in federated learning systems and environments.

In federated learning, a model is prepared by training the model locally at client nodes and then aggregating local models (or local model updates) into a global model without ever sharing the local data of the clients. Federated learning executions may differ in scale and may include very large numbers of participating client devices (nodes) and the data characteristics and device capabilities can vary widely among clients in the federation. In many instances, learning in this and other scenarios including heterogeneous scenarios, may be subject to concept drift.

As previously stated, selecting clients randomly for model aggregation can lead to slow convergence (i.e., more training rounds), inaccurate predictions and/or undesired biases. Embodiments of the invention relate to improving the convergence speed (time required for the global model to converge) by handling concept drift and non-independent and identically distributed (non-IID) data. More specifically, the communication overhead that emerges from slow convergence is addressed by selecting clients for model aggregation in a manner that avoids drifted and noisy clients.

Embodiments of the invention relate to selecting clients to deal with concept drift and data heterogeneity in the federation. The selection operation, in one example, is driven at least in part by the prediction entropy of the model. This mechanism provides a lightweight alternative for client selection and aggregation in the federated learning process and deals with concept drift and data heterogeneity in the federation. Embodiments of the invention relate to an entropy-based client selection and aggregation in federated learning that promotes robustness to concept drift and heterogeneous data in the federation.

During model aggregation, embodiments of the invention select clients to participate in the current model aggregation phase based on each client's prediction entropy. For example, prediction confidences can be extracted from the pre-argmax layer of a classification artificial neural network and entropy can be determined from the prediction confidences. The entropy is used to select and group clients in the federation for model aggregation without introducing much additional cost in terms of computation and communication resource usage.

By way of example, a classification model may be able to classify an input into one of 10 classifications. The prediction confidences reflect the probability of an input belonging to each of the classes. Generally, the output of the classification model is the classification with the highest probability or confidence. The entropy of the prediction confidences expresses the uncertainty of the prediction confidences. Because the prediction confidences, in one example, are a probability distribution, the entropy represents the uncertainty of the distribution.

In federated learning, one objective is to train, in an iterative manner, a model using the data available at individual nodes. The nodes, for example, may be edge nodes (or servers) that participate in federated learning with a central node (or server) at, for example, a datacenter. In each iteration or training round, sampled nodes (not all nodes are required to participate in the federated learning or in a given federated learning round) may run a stochastic gradient descent using local data to obtain local model updates. These local model updates are aggregated at the central note to compute a new or updated global model that can be returned to and incorporated into the local models.

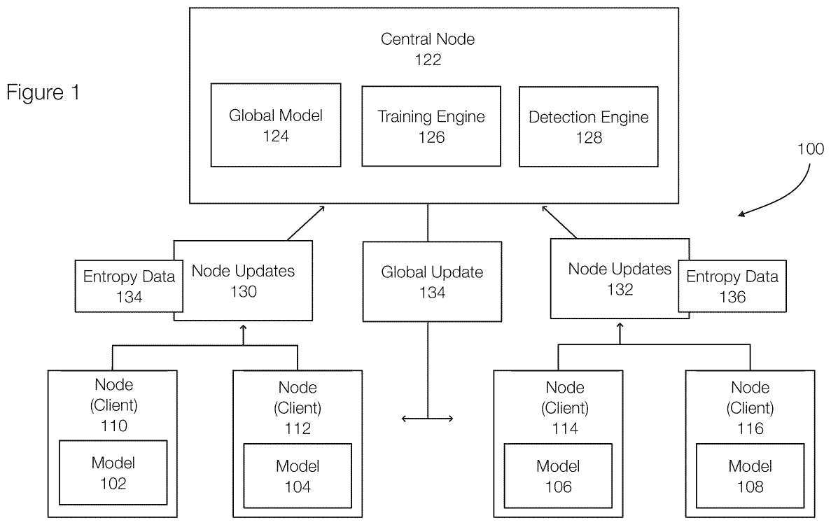

FIG. 1 discloses aspects entropy based client selection in the context of machine learning models and federated learning. FIG. 1 illustrates nodes 110, 112, 114, and 116, which include respectively, models 102, 104, 106, and 108. At the beginning of a federated learning operation (or round), the local models 102, 104, 106, and 108 are copies of the global model 124.

The nodes 110, 112, 114, and 116 may include or are associated with processors, memory, networking hardware, or the like and may by physical machines, virtual machines, containers, or the like. The nodes 110, 112, 114, and 116 are also examples of clients (or may include clients) of a central node 122. The nodes 110, 112, 114, and 116 may represent individual devices, clusters of devices, edge-based systems or servers, or the like.

The node 110 may train the model 102 using data collected/generated at the node 110. In other words, the data used to train the model 102 is distinct from data used to train the other models 104, 106, and 108. Further, data local to the node 110 is not shared with the other nodes that participate in the federated learning system 100. The data at the nodes 110, 112, 114, and 116 may be non-IID data.

As the models 102, 104, 106, and 108 are trained locally at the nodes 110, 112, 114, and 116, model updates may be generated or identified by each of the nodes or clients. Node updates 130 from the nodes 110 and 112 and updates 132 from the nodes 114 and 116 are transmitted to the central node 122. The updates 130 and 132 may be generated using secure and robust aggregation, such as may be obtained using a SHARE protocol.

The training engine 126 of the central node 122 uses the updates 130 and 132 to train/update the global model 124. After aggregating and incorporating the updates 130 and 132 into the global model 124, thus generating a new or updated global model 124, the training engine 126 may distribute the new or updated global model 124 (or an update such as new weights or gradients) to the nodes 110, 112, 114, and 116. The nodes 110, 112, 114, and 116 update their corresponding models 102, 104, 106, and 108 and the process repeats. This process may occur iteratively at least until, in one embodiment, the global model 124 converges. Once this occurs, the model 124 may be distributed to the nodes and used for inferences. Updates, however, may still be performed for various reasons (e.g., new data accumulated, drift detected).

In one example, only a portion of the updates 130 and 132 are used. More specifically, embodiments of the invention may select a subset of the nodes for the aggregation phase of a particular training round.

In this example, the node updates 130 and 132 may include, respectively, entropy data or information 134 and 136 for each of the clients 110, 112, 114, and 116 in the federation. The central node 122 selects nodes to include in the aggregation operations based on the entropy data 134 and 136. This allows the central node 122 to avoid drifted nodes and/or noisy nodes such that convergence time is improved or number of training rounds is reduced.

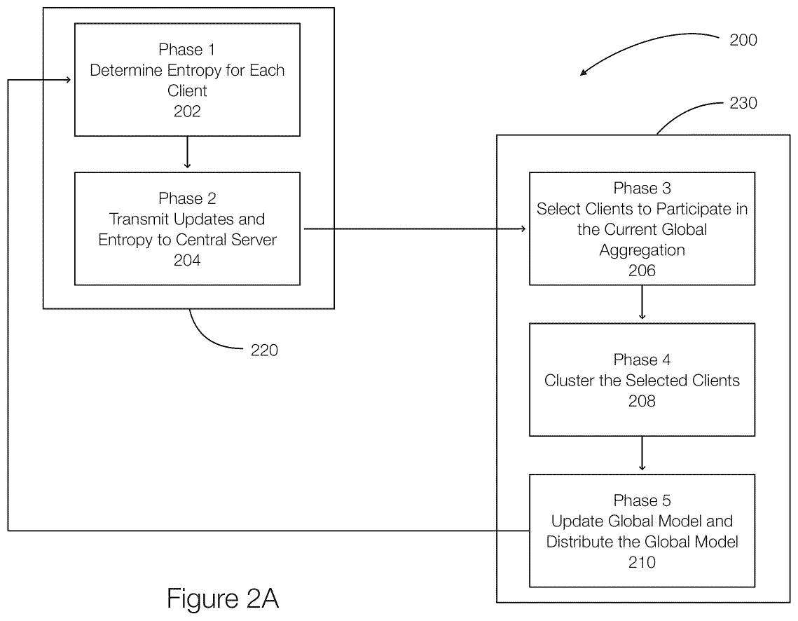

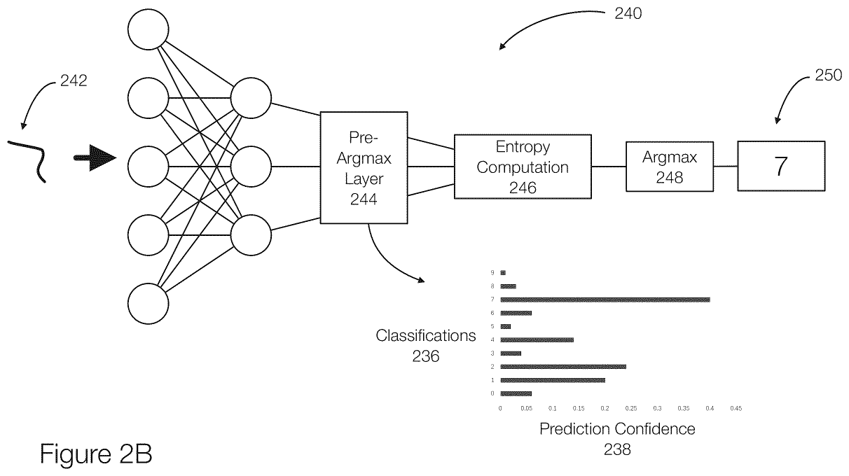

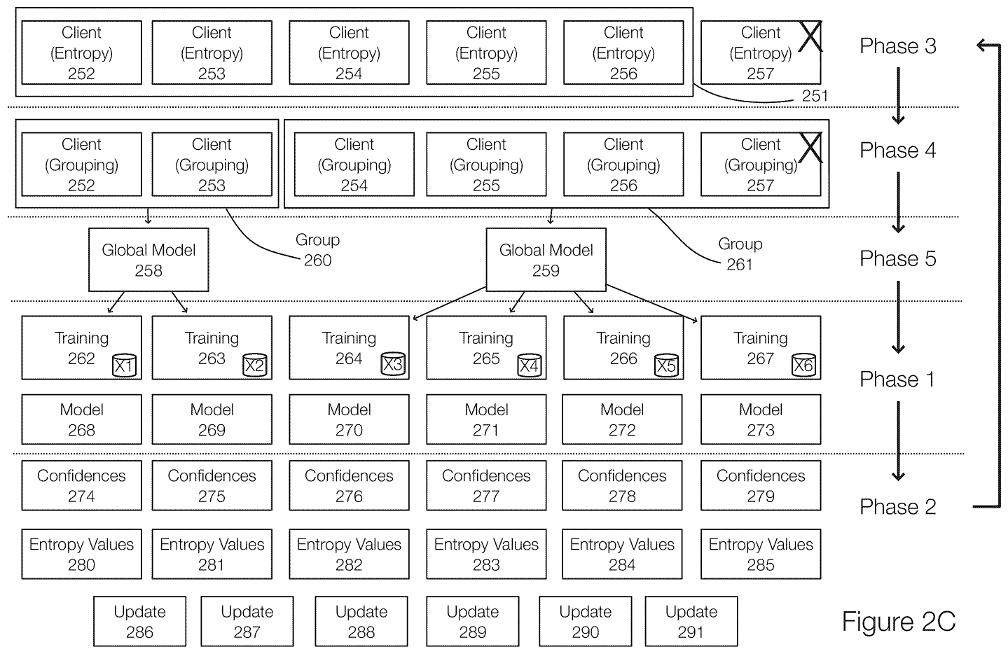

FIG. 2A discloses aspects of selecting clients to participate in a training round of federated learning. More specifically, FIG. 2A illustrates aspects of extracting confidence information, determining entropy values and selecting clients to participate in the training round in five phases. Phases 1 and 2 occur at the clients (e.g., local or edge nodes) or client side 220. Phases 3, 4, and 5 occur at the central node or server in one example or server side 230.

### Phases 1 and 2

FIG. 2A generally illustrates the phases of a training round of federated learning. A federated learning operation 200 may include determining 202 an entropy value or data for each client participating in the federated learning system. After the entropies of the nodes or clients are determined, the model updates and entropies of the clients are transmitted 204 to a central server.

In federated learning, each node or client begins with a federated learning model that has been initialized at a central server. Each client then performs local training using local data. To determine the entropy of a client, the pre-argmax layer is accessed to obtain the prediction confidences and entropy values or data are determined from the prediction confidences. Thus, for each client (each client c∈C) of a federation, the pre-argmax layer is accessed, the entropy is computed for the prediction confidences, and the entropy values are stored in a vector H_{c}. In one example, the entropy is calculated as a negative value of a summation of class prediction probability times its log vale for all available classes. In one example, for each set of prediction confidences, the framework calculates its entropy using the following equation:

$$E = - {\sum }_{y}^{\vert Y \vert} {p}_{y} * log ( {p}_{y} ) .$$

In this example, E stands for entropy, y∈Y represents the available classes predicted by the classification network, p_{y} is the prediction confidence for class y. The entropy calculation is a lightweight calculation that can be easily leveraged by resource constrained devices.

FIG. 2B discloses additional aspects of phases 1 and 2 performed at each of the clients in a federated learning system. This example uses a MNIST dataset, where there are 10 possible classification labels (numbers from 0 to 9). The model 240 is configured to classify an input 242. Thus, the input 242 (an image in this example) is input to the model 240 for classification.

In FIG. 2B, the input 242 is considered by the model 240. In this example, the pre-argmax layer 244 is accessed to obtain the prediction confidences 238. The prediction confidences 238 effectively provide a probability for each of the classifications 236. An entropy computation 246 is performed using the prediction confidences 242. The entropy values are stored in a vector H_{c}.

In phase 2, the entropy values vector H_{c} is accessed and the entropy values are encrypted. Homomorphic or secure aggregation may be used. In one example, the model parameters are transmitted to the central server along with the encrypted entropy values. Thus, the model gradients or model parameters (e.g., depending on whether fedSGD or FedAVG is used), which may also be encrypted, are sent to the central node.

### Phase 3

Once the gradients/parameters and entropy values are received by the central server, clients are selected to participate in the current training round based on the entropy values. The entropy values allows drifted nodes to be avoided.

Phase 3 may begin with the model gradients and encrypted entropy values of each client c (c∈C). In one example, the entropy values are normalized considering all clients such that the entropy values are between 0 and 1 in one example.

The normalized entropy values are then analyzed or evaluated for each client c (c∈C). The entropy values may be sorted in one example.

If the average normalized entropy of a client is lower than a confidence threshold t, the client is selected to participate in the current global model aggregation round. For the first round, the threshold t can be a user-defined parameter between 0 and 1. In one example, all clients that satisfy the threshold participate. In another example, the entropy values are processed until a predetermined number of clients that satisfy the threshold requirement are identified and selected.

If the average normalized entropy of a client is higher than the threshold t, that client will not participate in the current global model aggregation round. However, unselected clients still receive the new or updated global model at the end of the aggregation operation.

Clients are selected, in one example, while the number of selected clients is less than n, a user defined parameter between 2 and |C|, which may on the nature of the use case scenario and/or the federated learning task.

After clients have been selected, the current entropy threshold t for the next training round, may be updated using any methodology. As an example, it is possible to compute the average normalized entropy considering all selected clients from the previous step and set the entropy threshold to the average normalized entropy. After the first aggregation round, this threshold t is dynamically updated.

More specifically, in Phase 3, after receiving the gradients of the local models along with the respective encrypted entropy values H_{c} associated to the prediction confidences of each client c (c∈C), the central server computes the average entropy values for the client. The clients are normalized and sorted according to their average entropy (ascending order in one example).

Once the entropy values are averaged and normalized, the central server selects which clients should participate in the current model aggregation round. For each client (from the ordered list of clients), the central server determines whether the client's normalized entropy value is lower than a threshold t. If true, the client is selected to participate in the current aggregation round. For the first round, the threshold t is initialized as any number between 0 and 1. If the entropy of a client is higher than this threshold, this client is not selected.

This procedure repeats until at most n clients with entropy below the threshold are selected, the number of selected clients n is a user defined parameter. The value of n may depend on the nature of the use case scenario, cloud/edge devices technical characteristics, and/or the federated learning task.

Clients receiving learned patterns during local training will produce a confident prediction, visualized by a concentrated probability in the correct classes, e.g., low entropy. On the other hand, an unlearned pattern will output an even probability, showing low model prediction confidence, e.g., high entropy. This correlation can be exploited as a concept drift indicator and allows embodiments of the invention to avoid potential drifted clients by prioritizing and selecting only the clients with low entropy, decreasing noise in the aggregation step.

### Phase 4

In phase 4, the clients are clustered 208 based on entropy values, gradient values, and/or parameter values. Using one or more of these values, a set G of k groups (|G|=k) of similar clients (in this case, k is a hyperparameter that can be optimized) is created. The grouping can be performed using a clustering algorithm, such as K-Means. In one example, the optimal number of clusters can be found using, for instance, the Elbow and/or Silhouette tests. More specifically, during phase 4, the central server creates groups of clients in order to deal with heterogeneous scenarios.

### Phase 5

In phase 5, the global model is updated and distributed 210 back to the clients. More specifically, phase 5 starts with a set G of k groups of clients. These groups of clients allow the global model to be updated in a manner that accounts for heterogeneity. In one example, the central server executes federated learning aggregation (e.g., FedSGD or Fed AVG) to create a new global model for each group. This may result in multiple versions of the global model that accounts for the non-IID data or heterogeneous data of the clients.

Each of the clients in each of the groups receives the corresponding new or updated global model. All of the clients, not just the clients selected to participate in the current federated learning round, receive a new or updated global model. In one example, clustering the clients may be performed with respect to all clients. This allows clients to be associated to a specific group even if not participating in the current round of federated learning.

Once phase 5 is completed, the method returns to phase 1 or terminates when the model has converged. In one example, clients in different groups may receive different global models as described herein. However, in the event that a client model falls in a different clusters, the models may be indirectly mixed as the various phases are performed.

Embodiments of the invention thus select clients to participate in rounds of federated learning, which includes client selection and model update aggregation, based on client entropies. This promotes robustness to concept drift and heterogeneous data in the federation.

FIG. 2C discloses aspects of client selection and model aggregation in federated learning. FIG. 2C illustrates, by way of example only, a scenario or example where clients 252, 253, 254, 255, 256, and 257 have non-IID data (X={X₁, X₂, X₃, X₄, X₅, X₆}). In this example, the following conditions are considered. The target label space used to train each local model w per client contains 4 possible labels. A set C={c₁, c₂, c₃, c₄, c₅, c₆} with 6 clients (|C|=6), where the client 6 (client 257) is drifted and not selected due to its high entropy. a set G={g₁, g₂} containing 2 groups (|G|=k, k=2).

More specifically, FIG. 2C illustrates a set of clients 252, 253, 254, 255, 256, and 257 that are each associated with an entropy and illustrates aspects of federated learning starting with phase 3. Phase 3 occurs at a central node or central server and includes receiving entropy values from each of the clients 252, 253, 254, 255, 256, and 257. Using the entropy values, clients are selected to participate in the current federated learning round. Thus, the entropy values may be normalized, sorted, and compared to an entropy threshold value. Clients whose entropies are below the entropy threshold (or n clients) are selected to participate in the current aggregation operation. In this example, the clients 251 are selected and client 257 is not selected.

In the phase 4, which also occurs at the central node or server, the clients are grouped or clustered into groups. In this example, the clients 252 and 253 are grouped into the group 260 and the clients 254, 255, 256, and 257 are grouped into the group 261. As previously stated, the client 257 is not selected for update aggregation, but the client 257 is still grouped because the new or updated global model will be distributed in a group-wise manner.

In phase 5, a new or updated global model is generated for each of the groups 260 and 261. The global model 258 is generated using the updates from selected clients (client 252, and 253) from the group 260. The global model 259 is generated using the updates from selected clients 254, 255, 256 (not client 257 even though client 257 is part of the group 261).

In phase 5, the updates from the selected clients are combined (e.g., FedAVG) to generate a new or updated global model. In one example, because the clients have been clustered, multiple global models may be generated-one for each group. In one example, the updates from the clients in the group 261 are used to generate a new or updated global model 259. Similarly, updates from the clients in the group 260 are used to generate a new or updated global model 258.

The global models are distributed in a group wise manner. Thus, the global model 258 is distributed to all clients in the group 260 and the global model 259 is distributed to all clients in the group 261.

Once the clients of the federated system have received the new or updated global model, the next training round is initiated unless the global model has converged. Thus, the federated learning operation returns to phase 1. This includes training 262, 263, 264, 265, 266, and 267 the new or updated global model received from the central server using the corresponding local data. In one example, the models 268, 269 (e.g., the global model 258) and the models 270, 271, 272, and 273 (e.g., the global model 259) are trained using local data, which may be heterogeneous or non-IID data. Once local training is completed, the gradients or parameters may be included in an update transmitted to a central server.

The prediction confidences 274, 275, 276, 277, 278, and 279 are accessed (e.g., from the arg-premax layer) and entropy values 280, 281, 282, 283, 284, and 285 are determined for each of the clients. In phase 2, each of the clients 252, 253, 254, 255, 256 and 257 generate a corresponding update 286, 287, 288, 289, 290 and 291. The updates include the updates (e.g., gradients, weights, parameters) of the local model based on the training and entropy values, which may be encrypted. The updates are transmitted to the central server and phase 3 is performed by selecting clients based on the entropy values included in the updates 286, 287, 288, 289, 290 and 291.

The entropy-based aspects of federated learning improve the performance of the global model by addressing concept drift that might occur in some edge nodes or clients. Embodiments of the invention avoid selecting drifted and noisy clients for aggregation purposes such that the performance and convergence of the global model is not impacted by drift and noise. This reduces computational and communication overhead. In addition, the aggregation mechanism, which is based on model characteristics, promotes robustness to environments with heterogeneous data.

Embodiments, such as the examples disclosed herein, may be beneficial in a variety of respects. For example, and as will be apparent from the present disclosure, one or more embodiments may provide one or more advantageous and unexpected effects, in any combination, some examples of which are set forth below. It should be noted that such effects are neither intended, nor should be construed, to limit the scope of the claims in any way. It should further be noted that nothing herein should be construed as constituting an essential or indispensable element of any embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

It is noted that embodiments disclosed herein, whether claimed or not, cannot be performed, practically or otherwise, in the mind of a human. Accordingly, nothing herein should be construed as teaching or suggesting that any aspect of any embodiment could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

The following is a discussion of aspects of example operating environments for various embodiments. This discussion is not intended to limit the scope of the claims or this disclosure, or the applicability of the embodiments, in any way.

In general, embodiments may be implemented in connection with systems, software, and components, that individually and/or collectively implement, and/or cause the implementation of, federated learning operations, entropy related operations, prediction confidence determination operations, client selection operations update aggregation operations, or the like or combinations thereof. More generally, the scope of this disclosure embraces any operating environment in which the disclosed concepts may be useful.

New and/or modified data collected and/or generated in connection with some embodiments, may be stored in a data storage environment that may take the form of a public or private cloud storage environment, an on-premises storage environment, and hybrid storage environments that include public and private elements. Any of these example storage environments, may be partly, or completely, virtualized. The storage environment may comprise, or consist of, a datacenter which is operable to perform operations initiated by one or more clients or other elements of the operating environment.

Example cloud computing environments, which may or may not be public, include storage environments that may provide data protection functionality for one or more clients. Another example of a cloud computing environment is one in which processing, data storage, data protection, and other, services may be performed on behalf of one or more clients. Some example cloud computing environments in connection with which embodiments may be employed include, but are not limited to, Microsoft Azure, Amazon AWS, Dell EMC Cloud Storage Services, and Google Cloud. More generally however, the scope of this disclosure is not limited to employment of any particular type or implementation of cloud computing environment.

In addition to the cloud environment, the operating environment may also include one or more clients that are capable of collecting, modifying, and creating, data. As such, a particular client or server or other computing system may employ, or otherwise be associated with, one or more instances of each of one or more applications that perform such operations with respect to data. Such clients may comprise physical machines, containers, or virtual machines (VMs).

Particularly, devices in the operating environment may take the form of software, physical machines, containers, or VMs, or any combination of these, though no particular device implementation or configuration is required for any embodiment. Similarly, data storage system components such as databases, storage servers, storage volumes (LUNs), storage disks, servers and clients, for example, may likewise take the form of software, physical machines, containers, or virtual machines (VMs), though no particular component implementation is required for any embodiment.

As used herein, the term ‘data’ or ‘object’ is intended to be broad in scope. Example embodiments are applicable to any system capable of storing and handling various types of objects, in analog, digital, or other form.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

Following are some further example embodiments. These are presented only by way of example and are not intended to limit the scope of this disclosure or the claims in any way.

Embodiment 1. A method for performing federated learning in a system that includes clients and a central node, the method comprising: performing a training round of federated learning that includes: receiving updates from each of the clients at the central node, wherein each of the updates includes a model update and entropy values, selecting a set of clients from among the clients based on the entropy values of the clients, generating an updated global model using the model updates from the set of clients that were selected by aggregating the model updates, distributing the updated global model back to each of the clients.

Embodiment 2. The method of embodiment 1, wherein, for each of the clients, the entropy values are determined from prediction confidences obtained during model training at the clients.

Embodiment 3. The method of embodiment 1 and/or 2, wherein the model update includes gradients of the model being trained and/or parameters of the model being trained.

Embodiment 4. The method of embodiment 1, 2, and/or 3, wherein the set of clients includes n clients whose average entropy value is below a threshold entropy value.

Embodiment 5. The method of embodiment 1, 2, 3, and/or 4, further comprising normalizing the entropy values of the clients.

Embodiment 6. The method of embodiment 1, 2, 3, 4, and/or 5, further comprising updating the threshold entropy value after completing the training round.

Embodiment 7. The method of embodiment 1, 2, 3, 4, 5, and/or 6, further comprising clustering the clients into k groups, wherein k is a hyperparameter.

Embodiment 8. The method of embodiment 1, 2, 3, 4, 5, 6, and/or 7, further comprising generating the updated global model for each of the k groups using only model updates from selected clients in the corresponding groups.

Embodiment 9. The method of embodiment 1, 2, 3, 4, 5, 6, 7, and/or 8, wherein each of the clients in each of the k groups receives the corresponding updated global model for the group.

Embodiment 10. The method of embodiment 1, 2, 3, 4, 5, 6, 7, 8, and/or 9, further comprising performing additional training rounds until convergence is achieved.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of this disclosure also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality. Combinations of the above should also be included within the scope of computer storage media. Such media are also examples of non-transitory storage media, and non-transitory storage media also embraces cloud-based storage systems and structures, although the scope of this disclosure is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments may be downloadable to one or more systems or devices, for example, from a website, mesh topology, or other source. As well, the scope of this disclosure embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term module, component, client, agent, service, engine, or the like may refer to software objects or routines that execute on the computing system. These may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments may be performed in client-server environments, whether network or local environments, or in any other suitable environment. Suitable operating environments for at least some embodiments include cloud computing environments where one or more of a client, server, or other machine may reside and operate in a cloud environment.

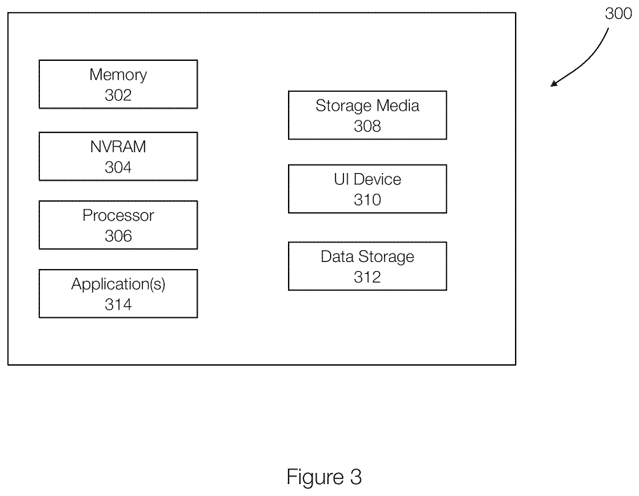

With reference briefly now to FIG. 3, any one or more of the entities disclosed, or implied, by the Figures and/or elsewhere herein, may take the form of, or include, or be implemented on, or hosted by, a physical computing device, one example of which is denoted at 300. As well, where any of the aforementioned elements comprise or consist of a virtual machine (VM), that VM may constitute a virtualization of any combination of the physical components disclosed in FIG. 3.

In the example of FIG. 3, the physical computing device 300 includes a memory 302 which may include one, some, or all, of random access memory (RAM), non-volatile memory (NVM) 304 such as NVRAM for example, read-only memory (ROM), and persistent memory, one or more hardware processors 306, non-transitory storage media 308, UI device 310, and data storage 312. One or more of the memory components 302 of the physical computing device 300 may take the form of solid state device (SSD) storage. As well, one or more applications 314 may be provided that comprise instructions executable by one or more hardware processors 306 to perform any of the operations, or portions thereof, disclosed herein.

The device 300 may also represent a computing system such as a server or set of servers, an edge based computing system, a cloud-based computing system, or the like. The computing system may be localized or distributed in nature.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The described embodiments are to be considered in all respects only as illustrative and not restrictive. All changes which come within the meaning and range of equivalency of the claims are to be embraced within their scope.

What is claimed is:

1. A method for performing federated learning in a system that includes clients and a central node, the method comprising:
performing a training round of federated learning that includes:
receiving updates from each of the clients at the central node, wherein each of the updates includes a model update and entropy values;
selecting a set of clients from among the clients based on the entropy values of the clients;
generating an updated global model using the model updates from the set of clients that were selected by aggregating the model updates;
distributing the updated global model back to each of the clients.

2. The method of claim 1, wherein, for each of the clients, the entropy values are determined from prediction confidences obtained during model training at the clients.

3. The method of claim 2, wherein the model update includes gradients of the model being trained and/or parameters of the model being trained.

4. The method of claim 1, wherein the set of clients includes n clients whose average entropy value is below a threshold entropy value.

5. The method of claim 4, further comprising normalizing the entropy values of the clients.

6. The method of claim 5, further comprising updating the threshold entropy value after completing the training round.

7. The method of claim 1, further comprising clustering the clients into k groups, wherein k is a hyperparameter.

8. The method of claim 7, further comprising generating the updated global model for each of the k groups using only model updates from selected clients in the corresponding groups.

9. The method of claim 8, wherein each of the clients in each of the k groups receives the corresponding updated global model for the group.

10. The method of claim 1, further comprising performing additional training rounds until convergence is achieved.

11. A non-transitory storage medium having stored therein instructions that are executable by one or more hardware processors to perform operations comprising:
performing a training round of federated learning that includes:
receiving updates from each of the clients at the central node, wherein each of the updates includes a model update and entropy values;
selecting a set of clients from among the clients based on the entropy values of the clients;
generating an updated global model using the model updates from the set of clients that were selected by aggregating the model updates;
distributing the updated global model back to each of the clients.

12. The non-transitory storage medium of claim 11, wherein, for each of the clients, the entropy values are determined from prediction confidences obtained during model training at the clients.

13. The non-transitory storage medium of claim 12, wherein the model update includes gradients of the model being trained and/or parameters of the model being trained.

14. The non-transitory storage medium of claim 11, wherein the set of clients includes n clients whose average entropy value is below a threshold entropy value.

15. The non-transitory storage medium of claim 14, further comprising normalizing the entropy values of the clients.

16. The non-transitory storage medium of claim 15, further comprising updating the threshold entropy value after completing the training round.

17. The non-transitory storage medium of claim 11, further comprising clustering the clients into k groups, wherein k is a hyperparameter.

18. The non-transitory storage medium of claim 17, further comprising generating the updated global model for each of the k groups using only model updates from selected clients in the corresponding groups.

19. The non-transitory storage medium of claim 18, wherein each of the clients in each of the k groups receives the corresponding updated global model for the group.

20. The non-transitory storage medium of claim 11, further comprising performing additional training rounds until convergence is achieved.
